(19) United States
(12) Patent Application Publication
(10) Pub. No.: US 2007/0242329 A1
(43) Pub. Date: Oct. 18, 2007

(54) Multibeam Internal Drum Scanning System

(76) Inventors: Hans Peter Ballegaard, Lystrup (DK); Brian Andersen, Lystrup (DK); Niels-Soren Bogh, Hadsten (DK)

Correspondence Address: MERCHANT & GOULD PC, P.O. BOX 2903, MINNEAPOLIS, MN, 55402-0903, US

(21) Appl. No.: 10/563,697

(22) PCT Filed: Jun. 25, 2004
(86) PCT No.: PCT/DK04/00453

§ 371 Date: Feb. 15, 2007

(30) Foreign Application Priority Data
Jul. 8, 2003 (DK) PA 2003 01045

(51) Int. Cl. G02B 26/10

(52) U.S. Cl. 359/201; 359/196

(57) ABSTRACT

An internal drum scanning system comprising a cylinder with an imaging surface, a laser source for generating a first and a second laser beam, a rotating deflector for deflecting the beams towards said imaging surface, a focussing lens for focussing the laser beams onto respective positions on said imaging surface, and a controllable optical elements which, during operation, is positioned such that its optical axis is displaced from the optical axis of the focussing lens, and which is adapted to direct the second laser beam onto said focussing leans at a varying incident angle causing the focussing lens to image the second laser beam onto the imaging surface such that, during relative rotation between the deflector and the cylinder, the focussing spot of the second laser beam is fixed relative to the optical axis.

This invention relates to an internal drum scanning system and, more particular, an internal drum scanning system where multiple laser beams are injected.

Internal drum scanning systems are widely used in the graphical industry. An internal drum scanning system comprises a cylinder, the “drum”, and a rotating deflector, e.g. a prism or a mirror, placed inside the cylinder such that it can be moved along the centre axis of the cylinder. A laser beam injected into the drum along the center axis is redirected by the deflector onto the inner surface of the drum. Due to the rotation of the deflector and its movement along the centre axis, different positions on the inner surface may be scanned by the laser, e.g. in order to expose a light-sensitive material disposed on the inner surface of the drum.

Internal drum scanning systems are popular, since they provide a number of advantages. For example, the optical path length is constant from the entrance point of the rotating element to the inner surface of the drum. This enables these types of systems to print with a very high printing quality and long-term stability.

However, it is a general disadvantage of such systems that the laser beams have to be injected from one of the openings of the cylinder along its centre axis, thereby limiting the number of laser beams that may simultaneously transfer image data onto the inner surface of the drum, thereby limiting the printing speed that may be achieved.

Meanwhile, the printing speed may be increased by turning up the modulation frequency of the laser beam and the rotation speed of the spinning element. In modem internal drum image setters the modulation speed is typically in the area of 100 MHz and the rotation speed typically varies from 10.000 to 60.000 rpm. Unfortunately, as the printing speed is increased, the dwell time on each pixel becomes shorter and shorter, thereby introducing new problems with the exposure of certain types of printing plates which have a reaction time longer than the available dwell time. The dwell time for these types of machines is typical 5-50 ns. Whereas the dwell time for slow plates are in the range from 20 ns to 2 μs.

U.S. Pat. No. 5,097,351 discloses a beam scanning system where two individually modulated adjacent scan lines are scanned simultaneously. This prior art system uses a piezo-controlled mirror which varies the angular orientation between two combined, orthogonally polarised beams so that one of the beams rotates about the other in synchronisation with the angular position along a scan line around the drum imaging surface.

Even though, the above prior art system allows the simultaneous scanning of two individually modulated adjacent scan lines, the above prior art system is limited to two beams.

Hence, it is an object of the present invention to provide a more flexible internal drum scanning system which allows the injection of two or more beams, thereby allowing the control of dwell times vs. printing speed and, thus, the printing on more types of printing plates and/or higher printing speeds.

The above and other problems are solved by an internal drum scanning system comprising
a cylinder having a centre axis and an inner surface providing an imaging surface to be scanned by at least two laser beams;
at least one laser source for generating a first and a second laser beam;
a deflector, mounted rotably relative to said cylinder around the centre axis of the cylinder, for deflecting said first and second laser beams towards said imaging surface;
a first focussing lens for focussing said first and second laser beams onto respective first and second positions on said imaging surface;
a first controllable optical element adapted to control the direction of the second laser beam to maintain, during relative rotation between the deflector and the cylinder, the second position fixed relative to the first position;
   wherein the first focussing lens defines a first optical axis being imaged by said deflector onto a centre position on the imaging surface; wherein, during operation, the first controllable optical element is positioned such that its optical axis is displaced at a radial distance from said first optical axis; and wherein the first controllable optical element is adapted to direct the second laser beam onto said first focussing lens at a varying incident angle causing the first focussing lens to image the second laser beam onto the second position such that, during relative rotation between the deflector and the cylinder, the second position is fixed relative to said centre position.

Hence, by providing a first controllable optical element positioned such that its optical axis is displaced at a radial distance from said first optical axis, where the first controllable optical element is adapted to direct the second laser beam onto said focussing lens at a varying incident angle causing the focussing lens to image the second laser beam onto the second position such that, during relative rotation between the deflector and the cylinder, the second position is fixed relative to said centre position, a system is provided allowing a plurality of beams to be injected into the internal drum such that the beams scan predetermined scan paths, in particular mutually parallel scan paths.

The term controllable optical element comprises any suitable optical element that may be controlled to provide a laser beam at varying angles with respect to an optical axis. Consequently, by combining the controllable optical element controlled to provide a laser beam at varying angles to a focussing lens operated as a Fourier lens, the position of the focal spot in the focal plane of the Fourier lens may be controlled, thereby allowing a compensation of the scan lines for any displacement of the focal spot caused by the rotation of the deflector.

It is a further advantage of the invention that the combination of the controllable optical element and a focussing lens operated as a Fourier lens provides a particularly simple optical system with few components.

In a preferred embodiment, the controllable optical element includes a collimator lens or a second focussing lens. It is an advantage that the internal drum scanning system provides a relatively simple construction requiring relatively few components. In particular, many internal drum scanning systems comprise a collimating lens and a focussing lens, thereby allowing the use of existing components to control the scan paths.

In particular, in a preferred embodiment, the first controllable optical element is mounted movably around a second optical axis; and the internal drum scanning system further comprises means for adjusting the position of the first controllable optical element to cause the first controllable optical element to rotate around the second optical axis at a predetermined frequency. In a preferred embodiment, the movement of the first controllable optical element is substantially along a circular trajectory, thereby causing, in cooperation with the first focussing tens, the focal spot to perform a corresponding circular movement. Consequently, the movement of the first controllable optical element can be controlled to compensate for the relative movement of the focal spot on the inner surface of the drum caused by the rotation of the prism.

In a preferred embodiment, the second optical axis is positioned at a radial distance from the first optical axis, preferably substantially parallel with the first optical axis, thereby allowing a plurality of scan lines to be scanned, without the need of a polarization coupling of the beams. In other embodiments, the second optical axis substantially coincides with the first optical axis, thereby providing a particularly compact system.

Preferably, the first focussing lens is operated as a Fourier lens, i.e. the first focussing lens is positioned relative to the deflector such that the optical path length from the first focussing lens to the imaging surface is substantially equal to the focal length of the focussing lens.

Further examples of controllable optical elements include a movably mounted lens, a rotable reflector such as a mirror, a grating, or the like.

In another preferred embodiment, the system further comprises means for polarising the first and a second laser beams, and means for polarization coupling the second laser beam generated by the first controllable optical element with the first laser beam resulting in a combined laser beam. The polarization-coupled beams can share the same beam paths, i.e. the same optical components, thereby providing a compact system that scans two scan paths.

The term deflector comprises any optical element suitable for redirecting the injected laser beam towards the inner surface of the drum. Examples of such deflector include a prism, a mirror, a grating, a hologram, or the like.

In a preferred embodiment, the deflector comprises a first deflection area for deflecting the first laser beam and a second deflection area for deflecting the second laser beam. Consequently, the first and second laser beams propagate along different optical paths, thereby eliminating the need for polarization coupling of the first and second beams. By providing an internal drum scanning system wherein at least one beam is injected off-axis as described above and in the following and wherein the deflector comprises a first deflection area for deflecting the first laser beam and a second deflection area for deflecting the second laser beam, a larger number of beams may be injected into the internal drum without causing undesired interferences.

In yet another preferred embodiment, the internal drum scanning system further comprises a detector arrangement for detecting a relative position of the first and second positions on the imaging surface, and a control unit for controlling the controllable optical element, where the control system is adapted to receive a position signal from the detector arrangement, and to control the adjustable element based on the received position signal. Hence, a system for automatically controlling the spot pattern imaged on the inner surface and, thus, the generated scan lines along the inner surface is provided, thereby increasing the scan quality of a multi-beam scanning system.

In a yet further preferred embodiment, the detector arrangement is positioned such that it receives at least a part of the first and second laser beams after the first and second laser beams have passed the deflector. Hence, the detector is located downstream from the deflector. In one embodiment the detector is adapted to receive at least a part of the deflected light from the deflector. In an alternative embodiment, the deflector is adapted to transmit a part of the first and second laser beams, and the detector is adapted to receive the transmitted part of the laser beams.

It is an advantage that such a detector system provides particularly accurate position detection. In particular, such a position detection system measures the effects induced by the entire optical system.

In the above system, an important issue of the movement of the controllable optical element is the size of the displacement and the speed of the movement.

Accordingly, the invention further relates to an arrangement for mounting an optical element movably within a predetermined plane relative to the optical element, the arrangement comprising
an optical element;
a number of elongated rods extending from the optical element in a direction substantially perpendicular to the direction of the predetermined plane;
a housing to which the elongated rods are connected;
   wherein at least a first one of said number of rods constitutes a first controllable bender element for causing the optical element to perform a movement in substantially the predetermined plane.

Hence, a compact construction of a movably mounted optical element is provided, in particular a compact construction in the plane of the movement.

Furthermore the mass of the moving system, which is an important parameter for the obtainable speed of the circular movement, is kept small.

Here, the term optical element comprises a lens, a mirror, a grating, a prism, or any other optical element.

In a preferred embodiment, a second one of said rods constitutes a second controllable bender element for causing the optical element to perform a movement in substantially the predetermined plane, and the first and second bender elements are connected to the optical element at respective first and second connection points of the optical element, the first and second connection points being located on opposite sides within the predetermined plane of a centre position of the optical element. Consequently, any tilts, rotations, etc. of the optical element outside the predetermined plane and caused by the bender elements are reduced.

Further preferred embodiments are disclosed in the dependant claims.

### BRIEF DESCRIPTION OF THE DRAWING

The invention will be explained more fully below in connection with a preferred embodiment and with reference to the drawing, in which:

FIGS. 1a-b schematically illustrate an embodiment of an internal drum scanning system with two injected beams;

FIGS. 2a-b illustrate the injection of multiple beams into an internal drum system;

FIGS. 3a-b illustrate the paths of two beams injected into an internal drum system if left uncompensated;

FIG. 4 illustrates an optical system for injecting a beam in a multibeam scanning system;

FIGS. 5a-b illustrates the rotation of the injected beam;

FIGS. 6a-b schematically illustrate an embodiment of an internal drum scanning system with four injected beams;

FIG. 7 illustrates an embodiment of an controllable optical element;

FIG. 8 illustrates another embodiment of an controllable optical element;

FIGS. 9a-b illustrate examples of driving signals in a multibeam scanning system;

FIGS. 10a-b illustrate another example of driving signals in an optical system for imaging a beam in a multibeam scanning system;

FIGS. 11a-e illustrate examples of the utilisation of the area of a spinner prism by multiple beams;

FIG. 12 illustrates an embodiment of a control system for a beam adjusting system;

FIGS. 13a-c illustrate a spot pattern detector system;

FIG. 14 illustrates another embodiment of a multibeam internal drum system with two injected beams;

FIG. 15 illustrates an embodiment of a multibeam internal drum system with three injected beams;

FIGS. 16a-b illustrate another embodiment of an controllable optical element;

FIG. 17 illustrates a 2D bender element;

FIGS. 18a-d illustrate the elimination of the error introduced by the rotating prism by means of the circular movement of a focussing lens;

FIG. 19 illustrates a three-beam system where the third beam is placed on top of the centre beam;

FIG. 20 shows another embodiment of an arrangement for detecting the beam positions;

FIGS. 21a-b illustrate an arrangement for a beam deflection including two mirrors;

In the drawings, same reference numerals refer to corresponding elements in the figures.

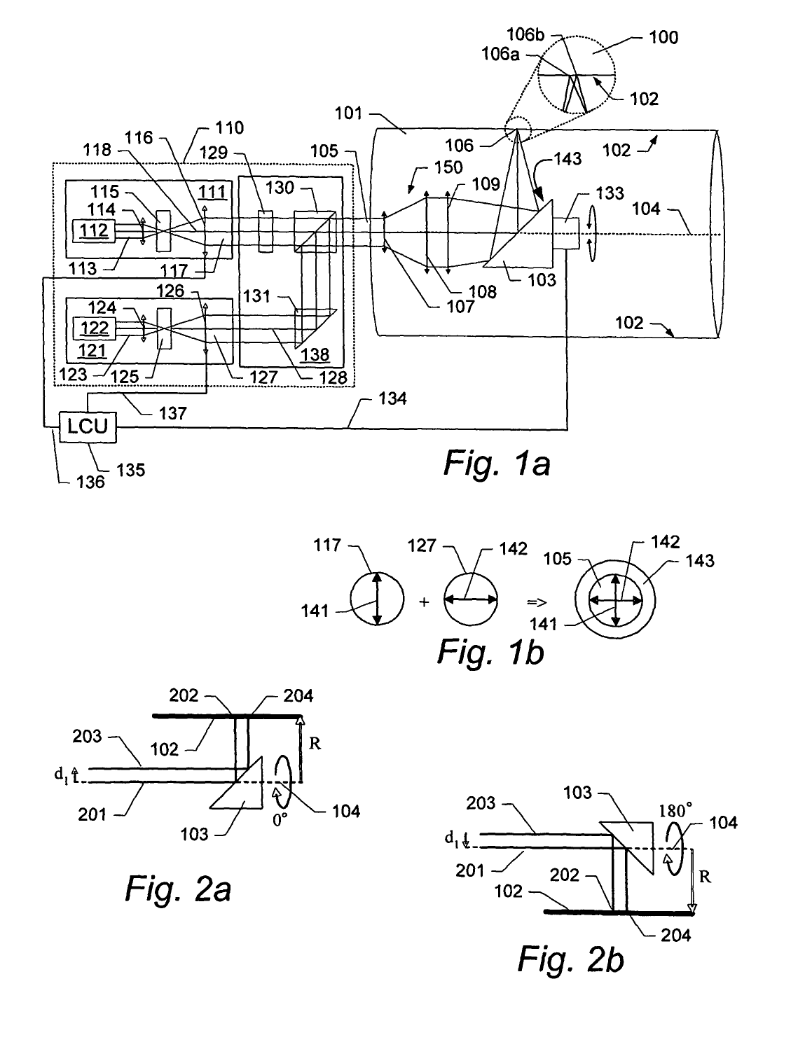

FIGS. 1a-b schematically illustrate an embodiment of an internal drum scanning system with two injected beams.

The internal drum scanning system comprises a cylinder 101, in the following also referred to as the drum. A laser beam 105 is injected into the drum 101 along the centre axis 104 of the cylinder. The system further comprises a prism 103 that is mounted inside the drum, rotably around the centre axis 104, such that the prism 103 redirects the injected laser beam 105 illuminating the rotating prism area 143 onto a focal spot 106 on the inner surface 102 of the drum 101. During operation, the prism rotates around the centre axis 104 causing the focal spot 106 to scan a scan line around the inner surface of the drum. Furthermore, the prism 103 is mounted movably along the axis 104, thereby allowing to successively scan different lines on the inner surface of the drum. It is understood that, instead of a prism, other types of reflectors may be used, such as a mirror, a hologram, a grating, or the like. Consequently, when a photo-sensitive material is disposed on the inner surface, e.g. by static pressure, a vacuum clamp, and or the like, the material may be exposed with a predetermined pattern along the scan lines. Hence an imaging surface is provided on the inner surface.

As will be described in greater detail below, in a multi-beam system the focal spot 106 comprises a corresponding plurality of individual focal spots, each scanning a corresponding scan line. In the example of FIG. 1a, the system is a dual beam system generating two focal spots 106a and 106b, as illustrated by the magnified view 100 of the focal spot 106.

The internal drum scanning system further comprises a laser system 110 for generating the laser beam 105. The laser system 110 comprises two laser units 111 and 121, each generating a linearly polarised laser beam 117 and 127, respectively. The laser system 110 further comprises a beam coupler unit 138 for generating a polarization-coupled laser beam 105 from the beams 117 and 127.

The beam coupler unit 138 performs a polarization coupling of the beams 117 and 127 according to any known polarization coupling method. In this embodiment, the beam coupler unit 138 comprises a λ/2-plate 129 for turning the polarization state of one of the two injection beams, in the example of FIG. 1a of beam 117, by 90°. The beam 117 is the directed from the λ/2-plate into a polarization cube 130. The beam coupler unit 138 further comprises a prism 131 that directs the second injection beam 127 into the polarization cube 130. The polarization cube polarization couples the incoming beams 117 and 127 resulting in a combined beam 105.

The effect of this polarization coupling is schematically illustrated in FIG. 1b. The symbols designated 117 and 127 illustrate the beam cross sections of the linearly polarized injection beams, where the polarization vector 141 of beam 117 is rotated 90° relative to the polarization vector 142 of beam 127.

Consequently, the combined beam 105 output by the laser system 110 and illuminating the prism area 143 includes two orthogonal polarization states.

The laser unit 111 comprises a laser 112, a focussing lens 114, an acousto-optical modulator 115, and a collimator lens 116. The laser 112 may be any suitable laser source, such as a semiconductor laser, e.g. a diode laser, a large-area diode laser, or the like. The focussing lens 114 focuses the laser beam emitted from the laser 112 onto the acousto-optic modulator for modulating the two laser beams according to a desired pattern to be scanned onto the imaging surface. The collimator lens 116 collimates the output beam from the acousto-optical modulator and generates a collimated laser beam 117, such that the lenses 114 and 116 operate as a beam expander.

Similarly, the laser unit 121 comprises a laser 112 emitting a laser beam 123, and a modulator assembly including a focussing lens 124, an acousto-optical modulator 125, and a collimator lens 126 generating a polarized collimated laser beam 127. In one embodiment, the laser units 111 and 121 are two identical units.

Consequently, the combined beam 105 comprises two orthogonally polarised beams each being individually modulated.

In one embodiment, each of the collimator lenses 116 and 126 is movably mounted such that the centre of the lens is displaced from the corresponding optical axis 118 or 128, and each lens performs a circular movement around the optical axis in a plane perpendicular to the optical axis. Hence, lenses 116 and 126 are offset at a radial distance from the optical axis, and the respective offsets perform circular movements around the optical axis. In this embodiment, both lenses 116 and 126 are movably mounted, thereby allowing an independent control of the circular movement of their respective offsets. In alternative embodiments, only one of the lenses is movably mounted, while the other lens is fixed and aligned to the optical axis.

In an alternative embodiment, instead of the collimator lenses 116 and 126, each of the focussing lenses 114 and 124 is movably mounted. Hence, in this embodiment, the centre of each of the focussing lenses is displaced from the corresponding optical axis of lenses 114 or 124, and each lens performs a circular movement around the optical axis in a plane perpendicular to the optical axis. Hence, lenses 114 and 124 are offset at a radial distance from the optical axis, and the respective offsets perform circular movements around the optical axis. A movement of the focussing lenses instead of the collimator lenses provides the same effect of causing, cooperatively with the rotating prism, the focal spot to draw a straight line on the inner surface of the drum. Since the focussing lenses 114 and 124 are typically smaller than the collimator lenses, displacing the focussing lenses is easier.

It is understood that, in alternative embodiments, the laser system 110 may comprise a single laser instead of two lasers. For example, in such an embodiment, the orthogonally polarized beams may be generated from the output of the single laser by a polarization-sensitive beam splitter.

The internal drum system of FIG. 1a further comprises a beam expander 150 including two lenses 180 and 108, and a focussing lens 109 for focussing the collimated beam 105 onto the focal spot 106.

The system further comprises a lens control unit 135 for controlling the movement of the collimator lenses 116 and 126 to cause, cooperatively with the rotation of the prism 103 and with the focussing lens 109, the two beam components of the polarization coupled beam 105 to be focussed onto respective focus spots 106a and 106b which describe parallel scan lines along the inner surface 102 of the drum. The lens control unit 135 receives a signal 134 from a rotation sensor 133 determining the rotational speed and phase of the rotating prism 103. The lens control unit 135 determines drive signals 136 and 137 controlling the movements of the lenses 116 and 126, respectively, as will be described in greater detail below. Hence, the laser system 110 with movable collimator lenses in both laser units allows the generation of two polarization coupled beams and, at the same time, allows a control of the circular movement of each of the beams. Preferably, the lens control unit further receives signals about the physical positions of the lenses, in order to ensure a stable operation. For example, the lens control unit may receive signals from capacitive position sensors or the like that detect the actual positions of the lenses as described below. The lens control unit may use these signals for correction the driving signal in order to achieve a stable spot pattern. Alternatively or additionally, in some embodiments the lens control unit receives signals indicative of the measured actual beam positions on the inner surface of the drum, e.g. from a quadrature photon detector, a PSD or like. An embodiment of an arrangement for detecting a spot pattern will be described below.

The effect of the rotation of lenses 116 and 126 will now be described in greater detail with reference to lens 116:

FIGS. 2a-b illustrate the injection of two beams into an internal drum system. As described above, in an internal drum system, a beam is injected into the drum along the center axis 104 of the drum, and the beam is redirected onto the surface 102 of the drum by a rotating prism 103, or the like. FIGS. 2a-b illustrate the injection of two beams 201 and 203, where beam 201 is injected substantially on the centre axis 104, while beam 203 is injected along the centre axis but offset by a radial distance d₁. Hence, the two beams are redirected onto two different positions 202 and 204, respectively, on the surface 102 of the drum. Due to the rotation of the prism 103 around the centre axis 104, the relative locations of the positions 202 and 204 change during a scan of the inner surface of the drum. In FIGS. 2a and 2b, the prism 103 is shown at two different points in time corresponding to half a revolution of the prism. As is illustrated in FIGS. 2a-b, the position 204 has moved onto the other side of position 202.

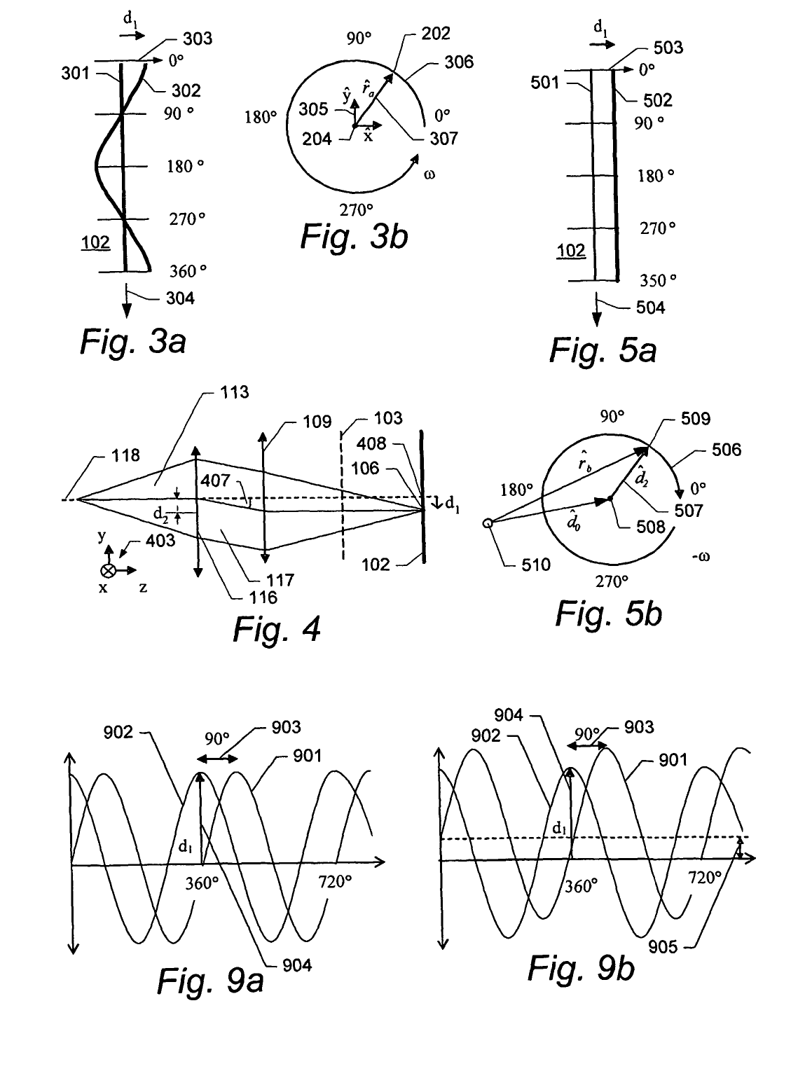

This effect is further illustrated by FIGS. 3a-b showing the paths of two beams injected into an internal drum system if left uncompensated.

FIG. 3a shows the resulting scan lines on the inner surface 102 of the drum. Line 301 shows the scan path of a beam on the surface of the drum, if the beam is injected coinciding with the centre axis. Hence, in this situation, the scan line 301 is a straight line. The axis 304 corresponds to the angle of rotation of the prism, while axis 303 corresponds to the displacement of the focal spot on the inner surface 102 of the drum from the centre line 301. Line 302 shows the scan path of a beam which is injected at an offset d₁ from the centre axis. The scan path 302 oscillates around the straight line 301 with amplitude _{d}. Hence, it is a problem that the two beams interchange their position on the surface of the drum when the prism rotates. Consequently, two columns of pixels cannot be printed next to each other. The pixels printed by the beam 302 appear on the wrong positions on the printing plate as a result of the prism rotation. In order to print with multiple beams the distance d₁ between the two columns of pixels should be constant.

FIG. 3b shows the relative displacement of the focal spot 202 of the beam injected off-axis from the focal spot 204 of the beam injected on-axis. During a full rotation of the prism, the focal spot 202 rotates once around the focal spot 204, as illustrated by the vector \hat{r}ₐ designated by reference numeral 307 which rotates around the focal spot 204 with a angular frequency ω, according to
r̅ₐ=d₁(\hat{x} cos(ωt)+ŷ sin(ωt))
where \hat{x} and ŷ are unit vectors of the corresponding coordinate system 305 having its origin in the focal spot 204. Hence, the focal spot 202 describes a circle 306 around the focal spot 204.

In the following, it will be described, how this problem is solved by properly encoding the input beams to the system.

FIG. 4 schematically illustrates an optical system for injecting a beam in a multibeam scanning system, e.g. the optical system for imaging one of the beam components in FIG. 1a. Generally, in an internal drum printing system, the injected modulated beams are focused on the printing plate into a spot of a certain size determined by the desired resolution. Examples of typical resolutions for internal drum systems are between 1000 to 5420 dpi.

The optical system of FIG. 4 comprises a focussing lens 109 for focussing the laser beam onto the printing plate on the inner surface 102 of the drum. In FIG. 4, the optical system is depicted with respect to the optical axis 118. It is understood that, in an internal drum system, the optical axis is bent at the rotating prism, the position of which is indicated by the dashed line designated 103 in FIG. 4. Hence, in an internal drum system, the optical axis is bent such that before the prism (i.e. to the left of the dashed line 103 in FIG. 4) the optical axis coincides with the centre axis of the drum, and after the prism (i.e. to the right of the dashed line 103 in FIG. 4) the optical axis points radially from the centre axis of the drum to the inner surface of the drum. Due to the rotation of the prism 103, the point 408 where the optical axis hits the drum rotates around the centre axis of the drum.

The optical system further comprises a collimator lens 116 placed in front of the focussing lens for collimating the incoming laser beam 113 before focussing it. This has the advantage that the focussing lens 109 can be moved along the center axis of the drum without changing the spot size of the focal spot 106 on the printing plate. It is understood that the optical system may comprise additional elements such as a beam expander, a modulator, etc., e.g. as described in connection with FIG. 1a. For simplicity, such elements are not shown in FIG. 4.

The distance between the focussing lens 109 from the printing plate 102 is substantially equal to the focal length f of the focussing lens. Hence, the focussing lens 109 is operated as a Fourier-lens that transforms angles into positions. Consequently, when a collimated beam 117 enters the focussing lens 109 at an angle of incidence 407, the focussing lens transforms the angle of incidence into a certain position 106 at a distance f to the right side of the lens. If the angle of incidence is 0° for all rays, the focal spot is located on the center axis at a distance f from the focussing lens 109, because the laser beam 117 is collimated. If the input angle 407 changes, the position 106 of the spot will change.

The collimator lens 116 is decentred with respect to the optical axis 118 by the distance d₂. Consequently, the collimated beam 117 enters the focussing lens 109 at an angle of incidence 407 different from 0°, and the position of the focal spot 106 on the printing plate is displaced from the optical axis by the distance d₁. The relation between di and d₂ is d₁=m·d₂, where m is a magnification defined by the actual optical system. If the collimator lens 116 is decentred simultaneously in the direction of the x- and y-axes of the coordinate system 403 with sinusoidal displacements and a phase shift of 90° between the two directions, the focal spot 106 describes a circle on the printing plate. Hence, a circular movement of the collimator lens around the optical axis 118 and in a plane perpendicular to the optical axis 118, results in a rotation of the focal spot 106. The radius of the circle drawn by the focal 30 spot is controlled by the amount of displacement of the collimator lens. Hence, by introducing a dc offset to the displacement in both directions the center position of the circle can be controlled as well, i.e. the spot can be controlled to rotate around a location distant from the optical axis.

FIGS. 5a-b illustrates the rotation of the injected beam due to the movement of a lens, e.g. the collimator lens of a beam expander. As described above, in the internal drum system a circular movement of the focal spot is introduced, if the laser beam is injected off-axis. The rotation speed of the prism corresponds to an angular frequency of ω of the circular movement. By moving the collimator lens around in a circle with radius d₂ with the equal angular frequency ω and a certain phase difference relative to the prism, a resulting movement of the focal spot is obtained.

FIG. 5a shows the scan line 502 on the inner surface 102 of the drum resulting from a beam injected off-axis at an offset d₁ through a collimator lens performing a circular movement. The scan line 502 is a straight line parallel to the line 501 which corresponds to the scan line drawn by the optical axis 118 in FIG. 4. The axis 504 corresponds to the angle of rotation of the prism, while axis 503 corresponds to the displacement of the focal spot on the inner surface 102 of the drum from the centre line 501. Consequently, two columns of pixels can be printed next to each other with a constant distance d₁ between the two columns of pixels.

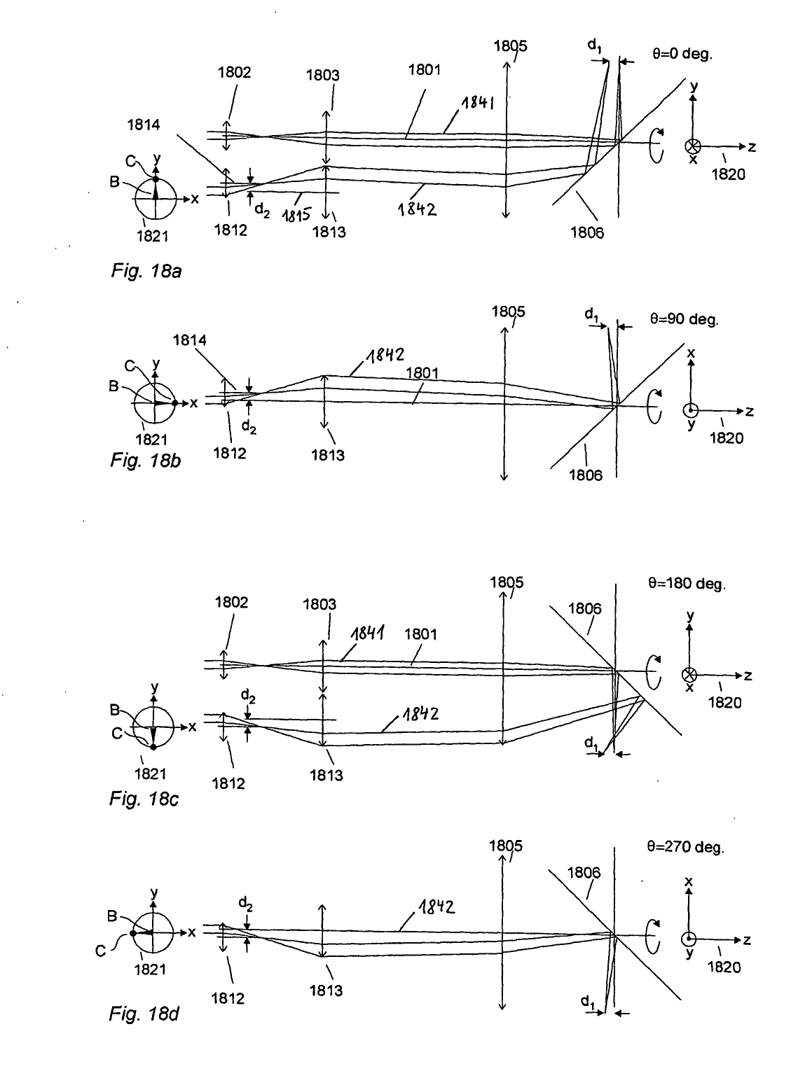

FIG. 5b shows the corresponding movement of the lens relative to its rest position 510. During operation, the lens moves along a trajectory 506, i.e. the position 509 indicates the position of the centre of the lines at a given point in time. During a full circle described by the collimator lens, its centre 509 rotates once around the point 508, as illustrated by the vector \hat{d}₂ designated by reference numeral 507, i.e. the vector \hat{d}₂ rotates around point 508 with an angular velocity ω, and a certain phase difference φ relative to the rotating prism. For example, in the example of FIG. 4, the point 508 lies on the optical axis 118. In FIGS. 18a-d below, the point 508 lies on the axis 1815. In FIG. 5b it is further assumed, that the centre of the circular movement is displaced by a constant offset \hat{d}₀ relative to the rest position 510, thereby allowing to compensate for a misplacement of the lens compared to the desired position, e.g. due to inaccuracies of the mounting or the like.

The resulting movement of the lens may thus be described according to
r̅_{b}=d₂(\hat{x} cos((ωt+φ)+ŷ sin(ωt+φ))+\hat{d}₀

Hence, the injection beam into the internal drum system is encoded such that it is decoded by the rotation of the prism yielding a straight scan line at a predetermined offset from the centre line 501, i.e. the combination of the rotation of the prism and the movement of the collimator lens yields an effective displacement equal to d₁. Hence, by adding the movement of FIG. 5b to the one on FIG. 3b, the circular movement of the focal spot on the printing plate is compensated.

Hence, in the above it has been described how parallel scan lines may be achieved in a multi-beam internal drum system by providing a movable collimator lens in cooperation with a Fourier lens. In particular, it has been disclosed how the movements of the movable collimator lens 116, and correspondingly of lens 126, of the embodiment of FIG. 1a are controlled to provide, in cooperation with the focussing lens 109 and the rotating prism 103, parallel scan lines.

It is understood that in alternative embodiments a different lens in front the focusing lens may be used instead of the collimator lens in order to encode the compensating motion, e.g. the focussing lenses 114 and 124 in FIG. 1a. It is further understood that, instead of a lens, the displacement may be introduced by a different optical element that is sensitive for displacement or tilting, e.g. a mirror, a prism, a grating or the like.

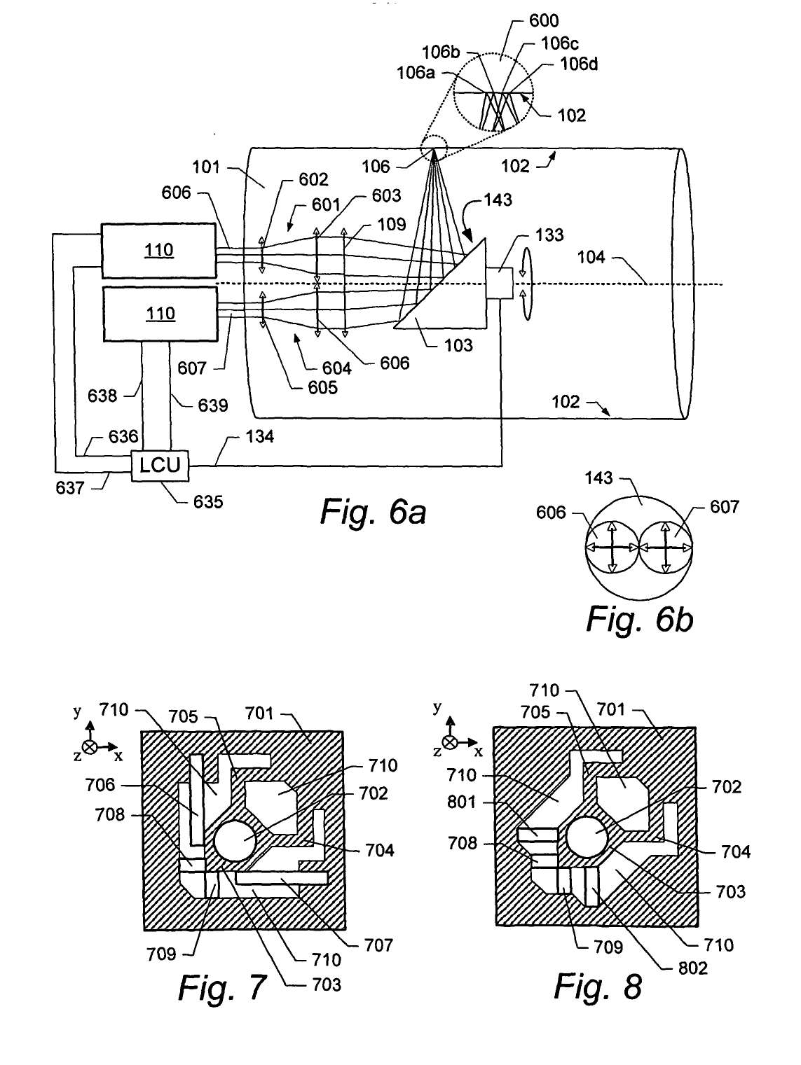

FIGS. 6a-b schematically illustrate an embodiment of an internal drum scanning system with four injected beams. The internal drum scanning system comprises a cylinder 101 having a centre axis 104. A prism 103, or another suitable reflector, is mounted inside the drum, rotably around the centre axis 104, such that the prism 103 redirects the injected laser beams illuminating the rotating prism area 143 onto a focal spot 106 on the inner surface 102 of the drum 101, as described in connection with FIG. 1a. Consequently, in this example, the focal spot 106 actually comprises four individual focal spots 106a, 106b, 106c, and 106d, as illustrated by the magnified view 600 of the focal spot 106.

The internal drum scanning system further comprises two laser systems 110 as described in connection with FIG. 1a for generating laser beams 606 and 607, respectively. Each of the laser systems 110 generates a combined laser beam including a pair of polarization coupled beams of orthogonal polarization states, each of which being emitted at an angle of incident controlled by a moving collimator or focussing lens, as described above. Hence, each of the laser systems includes two controllable optical elements controlled by a lens control unit 635. The lens control unit 635 receives a sensor signal 134 from a rotation sensor 133 indicative of the rotational speed and phase of the prism 103. The lens control system generates four sets of drive signals 636, 637, 638, and 639 for controlling the respective collimator/focussing lenses of the lasers system 110.

Each of the beams 606 and 607 is injected into the internal drum by a beam expander 601 and 604, respectively. The beam expander 601 includes lenses 602 and 603, while the beam expander 604 includes lenses 605 and 606. In this embodiment, all beams are injected off-axis, i.e. at a radial distance from the centre axis 104.

The laser system further comprises a focal lens 109 which is operated as a Fourier-lens, as described above. Both the polarization-coupled beams 606 and 607 share the same focal lens. The focussed beams are redirected by the prism 103 and focussed onto a focus spot 106. The four beams can use the same focussing lens and prism without causing distortions due to interference, since they are injected as two polarisation coupled beams 606 and 607 that illuminate different portions of the lens 109 and the prism area 143. This is illustrated in FIG. 6b showing the prism area 143 and the cross sections of the beams 606 and 607. Each beam comprises beam components having orthogonal polarisation states as described above in connection with FIGS. 1a-b.

Due to the rotations introduced by the prism 103 and the movements of the collimating lenses of the laser systems 110, the beams are focussed onto four respective focus spots 106a, 106b, 106c, and 106d, scanning respective parallel scan lines along the inner surface of the drum. Hence, by introducing individual displacements for all four beams, multiple lines of information can be written onto the printing plate by means of multiple beams.

FIG. 7 illustrates an embodiment of an controllable optical element. The controllable optical element comprises a lens 702 that is mounted such that it can be controlled to perform a circular movement in a plane perpendicular to its optical axis.

Generally, important issues of the movement of the lens in an controllable optical element in connection with an internal drum system are the size of the displacement and the needed rotation speed of the movement. The rotation speed of the movement should match the rotation speed of the rotating prism of the internal drum system, in order to allow compensating for the rotation of the prism. The maximal rotation speed of typical prisms is approx. 60 000 rpm corresponding to a frequency of the movement of the lens of approx. 1 kHz. The width of a column of pixels to be scanned is typically around 10 μm for typical scanning resolutions, thereby requiring the radius of the circular movement of the lens to be of the order of 10 μm in order to write two columns of pixels next to each other. In order to write 4 columns of pixels next to each other a radius of 20 μm of the circular movement of the lens is required. It is understood that if the magnification factor m is different from 1, the movement of the lens has to be correspondingly smaller or larger. The second requirement for the displacement of the lens is the centre position of the circular movement as controlled by a dc offset. If the magnification factor is close to one a total requirement of displacement of ±50 μm has been found to be sufficient in order to hold several beams.

In the arrangement of FIG. 7, the lens 702 is mounted in a housing 703 that is connected to a frame 701 via spring elements 704 and 705. For example, the spring elements may be machined from materials like steel or aluminium by using electrical wire discharge machining. The arrangement further comprises piezo-benders 706 and 707 which act as independent actuators for the x- or y-directions such that the spring elements 705 and 706 each generate a preload onto one of the actuators. The piezo-elements are mounted in a way so that the movement of one piezo-actuator is not hindered by the other. The arrangement further comprises position detectors 708 and 709 for determining the actual position of the lens 702 independently for the two axes. For example, the position detectors may be capacitive, inductive, resistive, or optical sensors or a combination of the above. The output from these sensors can be used with in a lens control system, as described below.

FIG. 8 illustrates another embodiment of an controllable optical element. As in the embodiment of FIG. 7, the controllable optical element comprises a lens 702 that is mounted such that it can be controlled to perform a circular movement in a plane perpendicular to its optical axis. The lens 702 is mounted in a housing 703 that is connected to a frame 701 via spring elements 704 and 705, as described above. According to this embodiment, the arrangement further comprises electromagnets 801 and 802 which act as independent actuators for the x- or y-directions in cooperation with the spring elements 705 and 706, respectively. As in the embodiment of FIG. 7, the arrangement further comprises position detectors 708 and 709 for determining the actual position of the lens independently for the two axes.

It is understood that an controllable optical element may also be based on alternative technologies allowing small precise movements, such as elektrorestrictive, magnetorestrective and electromagnetic technologies.

The above optical arrangements are electrically controlled. Hence, a control systems can be included that e.g. corrects the circular movement of the lens and synchronizes this movement to the rotation of the rotating element in the internal drum. The control system may further correct for e.g. dynamical changes in the rotation speed, misalignment, temperature changes, pointing stability, or the like. These control possibilities further allow the introduction of an auto calibration arrangement. By detecting at the output from the system on e.g. a CCD camera, the location and the stability of individual focal spots can be detected.

FIGS. 9a-b illustrate examples of driving signals for an optical system for imaging a beam in a multibeam scanning system. The arrangements described in connection with FIGS. 7 and 8 above may be controlled by electrical drive signals. In order to obtain a circular movement, each of the actuators may be driven by a sinusoidal signal with a relative 90°-phase shift between the signals for the x- and y-directions. Such signal may be obtained from a known function generator system.

FIG. 9a illustrates drive signals 901 and 902 for the x- and y-actuators of the above arrangements, respectively. The signals are plotted as functions of the angle of rotation of the internal drum prism. Both signals have an amplitude determined by the desired radius d₁ of the circular motion. In this example, the drive signal for the x-direction is a sine function while the drive signal in the y-direction is a cosine function with a 90°-phase shift relative to the sine function.

FIG. 9b illustrates another example of drive signals 901 and 902 for the x- and y-actuators of the above arrangements, respectively. In this example, the x-signal comprises an additional dc offset 905 in order to eliminate errors introduced elsewhere in the system. The amplitude 904 is directly linked to the radius of the circle, and the y-offset controls the displacement of the centre of the circle in the x-direction as described above.

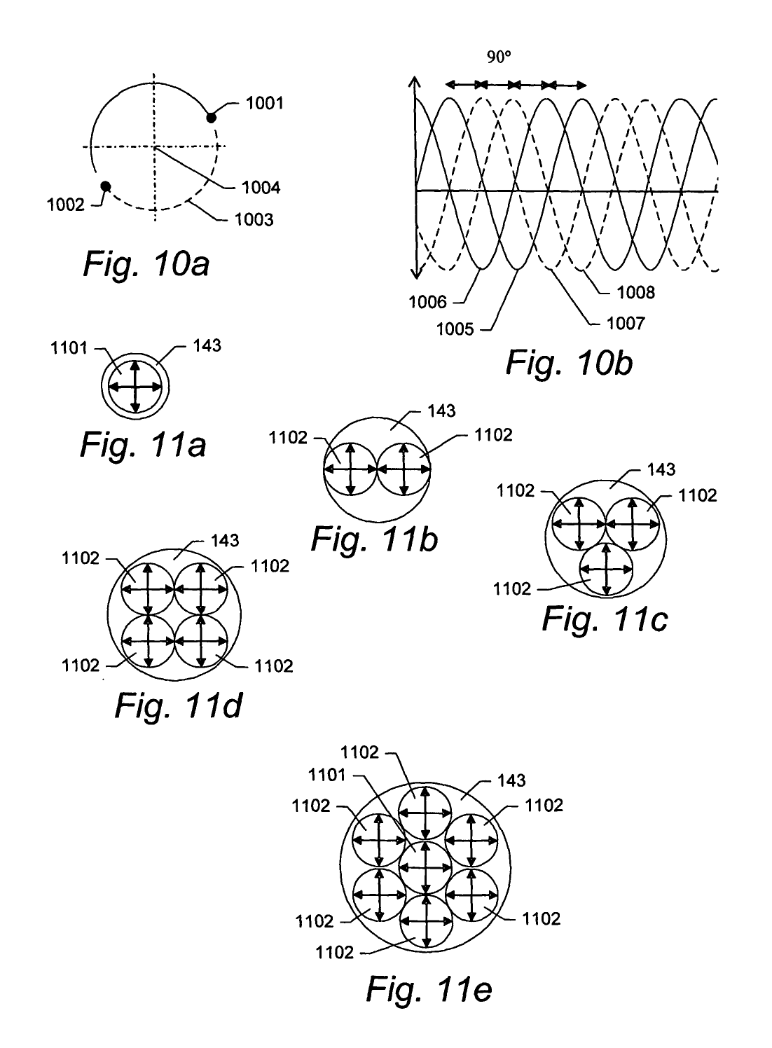

FIGS. 10a-b illustrate an example of driving signals for two controllable optical elements, e.g. the collimator lenses 116 and 126 of the laser system 110 of FIG. 1a. When more that one beam is adjusted within a mulitbeam system the phase of the drive signal controls the position of the beam in a circular orbit (in FIG. 10a, the corresponding opposite rotation caused by the prism is disregarded) while the dc offset controls the position of the centre of the orbit. FIGS. 10a-b illustrates an example of a 2-beam system where both beams are moving 180° displaced in the same orbit. FIG. 10a illustrates the circular movements of two focal spots 1001 and 1002 along an orbit 1003 around the orbit centre 1004. FIG. 10b illustrates the corresponding driving signals. Lines 1005 and 1006 correspond to the x- and y-signals, respectively, for the optical element controlling the position of spot 1001, while lines 1007 and 1008 correspond to the x- and y-signals, respectively, for the optical element controlling the position of spot 1002. Here, the x- and y-driving signals for the two individual beams are 180° out of phase. The same principles can be used for a three beam system by using a phase delay of 120°. Note, that the phase delay between the x- and y-driving signals is 90° for each of the beams. Hence, N beams may be controlled by controlling the corresponding phase shifts, amplitudes and dc-offsets.

Alternatively, N beams may be controlled by having one or two beams in one orbit with radius x₁, one or two beams in an orbit with radius 2x₁, one or two beams in an orbit with radius 3x₁ and so on. In the case with two beams in one orbit the beams should be separated with 180°. It is clear that one beam could be placed in the orbit centre 1004.

It is understood that arbitrarily shaped beam paths along the inner surface of the drum may be constructed for each of the beams by defining the corresponding driving signals in a suitable way. Hence, arbitrary spot patterns may be made on the inner surface of the internal drum. Correspondingly, the movements introduced by the optical elements may be different from circular movements.

It is further understood that movements in the z-direction, i.e. the direction of the optical axis, may be introduced in a similar way, e.g. by introducing a z-translation to the piezo-lens of FIG. 7. Such a displacement has the benefit that the z-position of the focal spots of the individual beams can be controlled. For example, this can be used to e.g. adjust the spot size of the individual spots.

FIGS. 11a-e illustrate examples of the utilisation of the area of a spinner prism by multiple beams. As mentioned above, in an internal drum system as described in connection with FIG. 5a, more than four beams may be injected by adding additional laser systems and beam expanders in front of the focal lens. Since no more than than two polarization coupled beams may be injected utilising the same lens area or the same prism area. Hence, in a multi-beam system, the beams are preferably arranged around the centre axis to illuminate different areas of the rotating prism in the internal drum system.

Generally, the rotating prism in an internal drum configuration requires careful design, since it should be able to perform fast rotations, e.g. 60 000 rpm, and, at the same time, random tilts and de-centering should be avoided. Aerodynamically and aerostatic spinner systems are known in the art which allow such rotations to a satisfying level. However, these technologies set limits for the mass and, thus, the dimensions of the rotating prism. In practice, the clear aperture of a prism in aero dynamical spinners is limited to approximately Ø25 mm, and the clear aperture of a prism in an aero static spinner is limited to approximately Ø100 mm. Furthermore, the size of the focal spot on the printing plate is directly depended on the beam diameter at the focal lens. Therefore a certain minimum beam diameter is desirable at the rotating prism, preferably between Ø15 to Ø25 mm. Therefore, the available prism area should be used with attention.

FIGS. 11a-e illustrate how the prism area 143 can be utilised to hold several beams of a multibeam system such that beams from different sources do not share the same path is space, unless a polarization coupling is used.

In FIG. 11a, two beams having different polarisation states share the same prism area as indicated by the cross-section 1101. If more beams are injected, the area 143 has to be increased.

FIG. 11b shows an example of two off-axis beam pairs 1102, each comprising two polarization coupled beams of different polarization states, illuminate different areas of the prism area 143. Similarly, FIGS. 11c and 11d illustrated the utilisation of the prism area 143 for three and four off-axis polarization coupled beam pairs, respectively. Finally, FIG. 11e shows a prism area with a centre beam pair 1101 surrounded by 6 further beam pairs 1102, allowing a total of 14 beams to be simultaneously injected. Hence, by doubling the prism diameter makes space for 8 beams and a tripling makes space for 14 beams. Preferably, in the cases of FIGS. 11b-e, aero static spinners are used, since they provide a larger prism area.

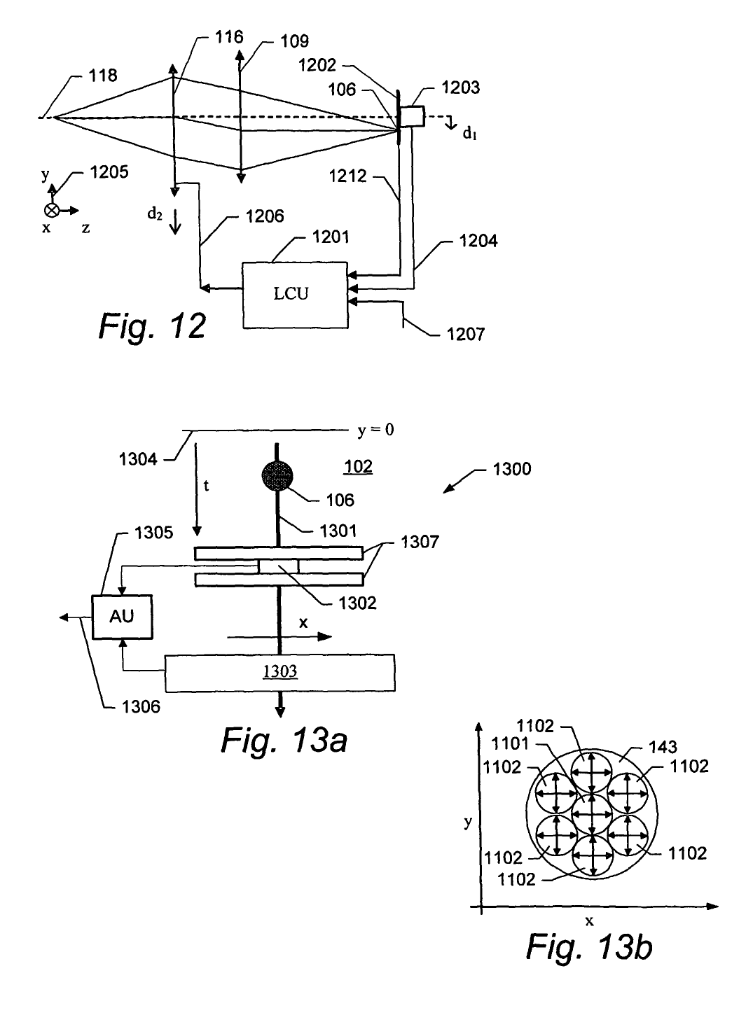

FIG. 12 illustrates an embodiment of a beam adjusting system. By turning on a single beam of a multi-beam system at a time, and by replacing the spinner prism with a rotating position sensitive detector (PSD) chip placed in the focal distance of the Fourier lens, the parameters for the movement of the corresponding collimator/focussing lens may be measured and adjusted to achieve the desired scan line. This is possible because the xy-signals from the rotating PSD can track the circular path of the movement of the lens. From this information the rotation center and radius of the movement can be determined and the driving signal can be adjusted to fit the requirements. FIG. 12 schematically shows an adjustable collimator lens 116 and the focussing lens 109 of an internal drum system, e.g. the system of FIG. 1a. The remaining components of the internal drum system, in particular further adjustable collimator lenses are not shown in FIG. 12. In the system of FIG. 12, instead of the spinner prism, a PSD chip 1202 is placed in the optical path of the optical system. The PSD chip is placed such that the distance between the focussing lens 109 and the PSD chip 1202 is substantially equal to the focal length of the focussing lens 109. The PSD chip 1202 is rotably mounted around the optical axis 104. The rotation of the PSD chip is controlled by a spinner control unit 1203 corresponding to the control system of the spinner system in the internal drum system. The PSD chip generates a sensor signal 1212 indicating the position of the focal spot 106 of the laser beam on the chip, i.e. the x- and y-cordinates of the focal spot with respect to the coordinate system 1205. The sensor signal 1212 is fed into a lens control unit 1201 which determines the amplitude, frequency, and phase of the driving signals for the collimator lens 116. The lens control unit 1201 further receives a PSD speed and phase signal 1204 from the spinner control unit 1203, from a rotation sensor, or the like. The lens control unit 1201 determines the driving frequency and phase of the moving lens 116 from by comparing the phase and speed signal from the spinner controller unit with the PSD information. During subsequent operation, the PSD speed signal is replaced by a corresponding signal from the rotating prism as described above. The lens control unit 1201 further receives setup parameters 1207 including the desired position of the focal spot 106. This information, together with the sensor signal 1203 is used by the control unit 1201 to determine the phase, the amplitude, and the dc offset of the driving signal. The control unit 1201 feeds the determined driving signals 1206 for the x- and y-movements of the collimator lens 116 to the corresponding actuators of the lens 116 as described above. The lens control circuit 1201 is adapted to determine the drive signals 1206 such that the laser beam hits the PSD at a constant position 106, as determined by the setup signal 1207, relative to the rotating PSD chip.

Furthermore, the roundness of the movement of the lens 116 can be controlled and, if necessary, corrected by manipulating the xy-driving signals. Hence, all information important for aligning the focal spot can be determined.

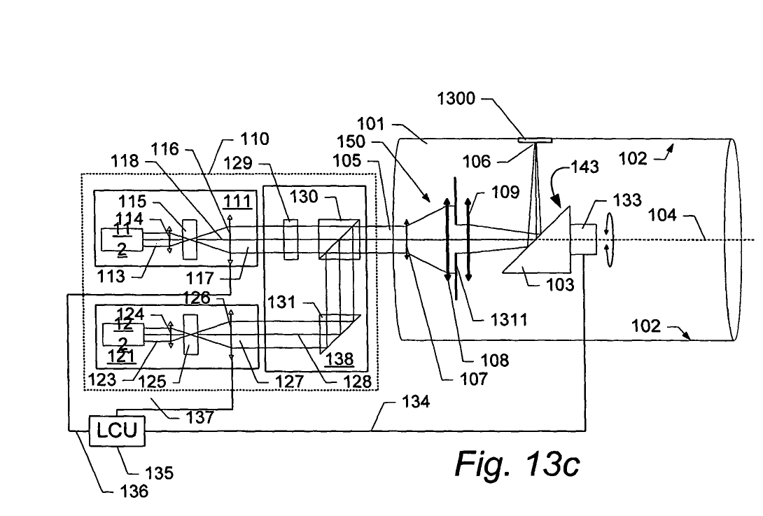

FIGS. 13a-c illustrate a spot pattern detector system. For different applications, the desired pattern of focal spots may be different. For example, when printing or scanning with different resolutions, the distance between neighbouring scan lines should be different accordingly. It is an advantage of the systems described above and in the following that the automatic alignment of several beams is limited to the determination of the desired position of each beam on the printing plate. In the following it will be described how an automatic calibration of spot patterns may be perfomed, i.e. how the pattern of focal spots on the printing plate may be adjusted to match a selected pattern for a given printing job.

FIG. 13a schematically illustrates a system for recognizing a spot pattern on the printing plate. The system, generally designated 1300, comprises a slit 1307 with a photo diode 1302 and a linear PSD 1303, both arranged inside the drum of an internal drum system, e.g. disposed on the inner surface 102 of the drum. When a focal spot 106 scans along a path 1301 on the inner surface 102 of the drum, it passes the slit 1307 with the photo diode 1302 and the linear PSD 1303 once during every revolution of the spinner prism (not shown). The x-direction of scan line 1301 may thus be measured by the linear PSD 1303. The relative y-position of a focal spot relative to other focal spots of a spot pattern is determined from the “fly-time” of the spot from an arbitrary y=0 position 1304 on the cylinder to the slit with the photodiode 1302. The photo diode 1302 is also used as a pre-trigger for the linear PSD 1303. Hence, the xy-position of the focal spot in a spot pattern may be determined by turning on one beam at a time and by operating the internal drum system to scan a scan line with the single beam while the detector arrangement of FIG. 13a is disposed inside the drum. By turning one beam on a time the xy-information of all beams can be obtained, as illustrated in FIG. 13b. The x-position from the PSD 1303 and the timing information are fed into an analysis unit 1305, e.g. a suitably programmed microprocessor, a personal computer, or the like. From this xy-information, the analysis unit 1305 determines the phase, the amplitude, and the dc-offsets of the driving signals 1306 for the piezo-lenses are as described above. The frequency is determined from the rotation speed of the rotating prism. For example, the analysis unit 1306 may feed the determined driving signals directly to the lens control unit.

It is understood that by expanding the detector system of FIG. 13a with additional similar detector systems positioned at different angles within the drum, information about deviations of the scan line 1301 from a straight line may be detected, i.e. S-curves caused by imperfections of the optical system of the internal drum system may be measured. For instance, according to Shannon's Sampling Theorem, by placing two detectors separated by 180° at the inner surface of the drum it is possible to determine amplitude, phase and frequency of sinusoidal S-curves with a period equal to or larger than the circumference of the drum. Hence, the above detector system may provide information allowing a lens control system to compensate for such imperfections. The system also makes it possible to measure the distance between two adjacent beams in an N-beam system. Thus, if the measured distance is 12 mμ and the target is 10 mμ the error can be corrected by decreasing the amplitude of the driving signal applied to the actuated lens or the actuated mirror.

The above detector system may be placed on the inner surface of the cylinder itself or in a partly deflected path of the output beam by the use of mirrors, beam splitters or like.

FIG. 13c illustrates an embodiment of a beam adjusting system with an improved position resolution of the PSD detector. The system of FIG. 13c corresponds to the system of FIG. 1a but with a position detector 1300 as shown in FIG. 13a placed on the inner surface 102 of the drum 101.

In order to obtain the highest possible position resolution from the PSD detector the signal to noise ratio of the current signal from the PSD should be optimised, as will be shown by the following derivation. The pn junction of the PSD generates a current that is proportional to the beam power incident onto the PSD:
I_{signal}=ηP (1)
where η is the responsivity of the PSD and P is the power of the beam incident onto the PSD. The first of two noise currents generated by the PSD is known as shot noise and is given by:
Iₛₙ=\sqrt{2q(I_{signal}+I_{d})f_{B}} (2)
where q is the electron charge, I_{d} is leakage current of the PSD and f_{B} is the bandwidth of the PSD amplifier system. The second noise current is known as Johnson noise and is given by:

$${I}_{jn} = \sqrt{\frac{4 {kTf}_{B}}{{R}_{PSD}}} \qquad ( 3 )$$

where k is Boltzmann's constant, T is the temperature in Kelvin, and RPSD is the PSD resistance. The total current noise is given by
Iₜₙ=\sqrt{Iⱼₙ²+Iₛₙ²+Iₐₙ²} (4)
where Iₐₙ is the equivalent noise current from the amplifier. When the ratio between the current noise and a small current change approaches one the resolution of the PSD has been reached (more advanced measuring techniques such as lock-in amplifiers allows higher resolutions to be obtained). By using this assumption the following equation gives the resolution when the total noise current and signal current are known:

$$δ = \frac{{L}_{x} {I}_{tn}}{{I}_{signal}} \qquad ( 5 )$$

where Lₓ is the length of the PSD. Values of approximately δ=0.1 mμ are acceptable for this application. From the above equations it is clear that the value of δ can be decreased by increasing the photodiode signal current I_{signal} because the Johnson noise Iⱼₙ is constant and the shot noise Iₛₙ only increases with the square root of I_{signal}. This indicates that the power of the beam incident onto the PSD should be as high as possible. However, photodiodes and PSDs are characterised by an upper intensity limit that must not be exceeded in order not to degrade the performance of the detector. Exceeding the intensity limit lowers the detectors ability to measure short pulses correctly and it lowers the linearity of the detectors input-output characteristic.

The power incident onto the PSD may be optimised while ensuring that the light intensity limit is not exceeded by increasing the focal spot diameter of the focal spot on the inner surface of the drum. One method to achieve this is shown in FIG. 13c where an aperture 1311 has been inserted in front, i.e. upstream, of the focus lens 109. The effect of the aperture 1311 will be shown by the following derivation. If the beam 105 has a Gaussian intensity distribution, then the power of the beam will be reduced because of the aperture. The power of the beam after being transmitted through the aperture 1311 is given by

$$P = {P}_{0} ( 1 - {ⅇ}^{\frac{- 2 {r}_{a}^{2}}{{w}^{2}}} ) \qquad ( 6 )$$

where rₐ is the radius of the aperture 1311, P₀ is the power of the beam 105 in front of the aperture and w is the radius of the beam in front of the aperture. Here w is the distance from the centre of the Gaussian beam to the point where the intensity has decreased by a factor of e⁻² compared to the intensity at the centre of the beam.

Equation (6) is only exactly valid if the incident beam is centred with the aperture. Even though this may not be the case in some embodiments, the error is negligible when the angle between the beam 105 and the optical axis 104 is small or when the aperture is placed such that the displacement of the beam relative to the centre of the aperture is small. When the radius of the aperture 1311 decreases, the radius of the focal spot 106 increases as shown by the relation

$${w}_{spot} = \frac{λ f}{π {r}_{a}} \qquad ( 7 )$$

where wₛₚₒₜ is the focal spot radius, λ is the wavelength of the light and f is the focal length of the focus lens 109. Equation (7) is an approximation to the physical value, which is also affected by the aberrations of the lens 109. Furthermore, when the radius rₐ of the aperture becomes very small, the intensity distribution of the spot will not be purely Gaussian but will show some diffraction effects. However, this will not affect the accuracy of the position detection measurement since any deviations from the Gaussian distribution will remain rotational symmetric.

The maximum intensity at the centre of the focal spot is given by:

$${I}_{0} = \frac{2 P}{π {w}_{spot}^{2}} \qquad ( 8 )$$

From Equations (6) and (8) it is clear that the intensity decreases at a higher rate than the power when rₐ is decreased. Therefore it is possible to obtain a large reduction in intensity while the power is less reduced. A typical value for the maximum recommended intensity for a PSD detector is 3 W/cm². From this value the maximum aperture radius can be calculated, and from this the resolution from Equation (5) can be controlled in relation to the initial resolution requirement.

It is understood that the aperture may also be placed at a different position than shown in FIG. 1a, e.g. upstream of the lens 107. Furthermore, in embodiments like the one shown in FIG. 6a, multiple apertures are preferably positioned, on in each of the beams 606 and 607.

In one embodiment, the above beam adjustment system may be operated as follows: Before the exposure of a printing plate, the aperture(s) is/are controlled to close to the desired aperture radius. Subsequently a position detection is performed, a corresponding feedback signal is fed to the lens control unit, and the lens control unit adjusts the lens actuation in accordance therewith in order to optimise the beam adjustment. After successful beam adjustment, the aperture(s) is/are opened and the exposure process is started.

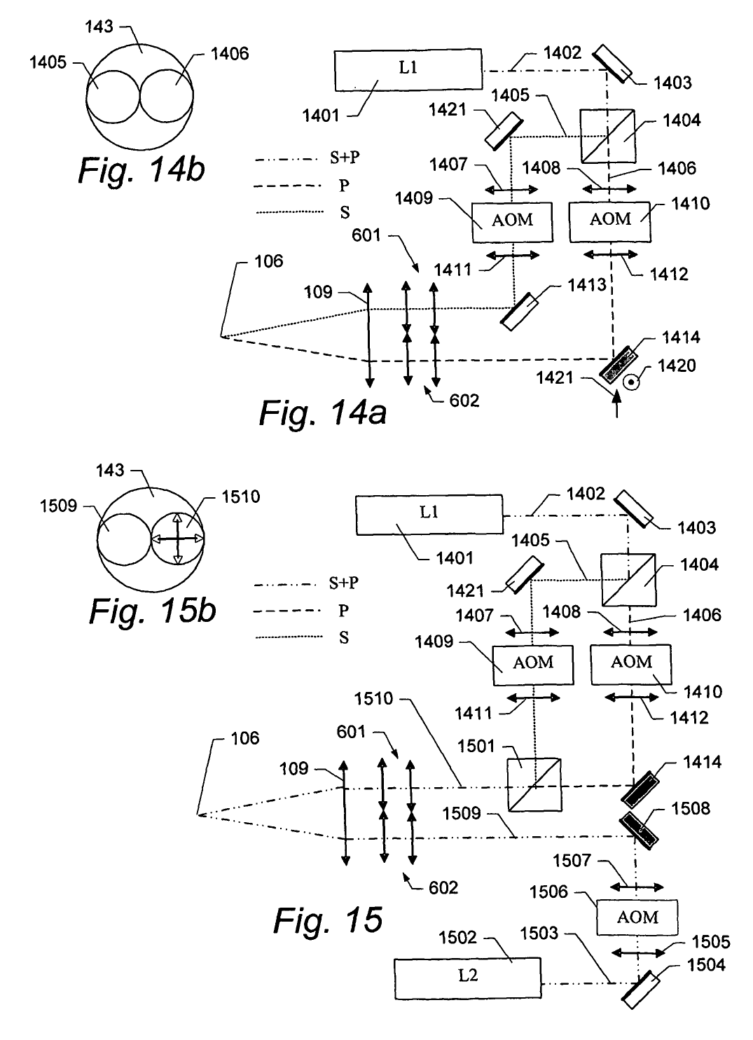

FIGS. 14a-b illustrate another embodiment of a multibeam internal drum system with two injected beams. This example illustrates an embodiment of a dual beam system using adjustable mirrors. The system schematically shown in FIG. 14a comprises a laser 1401 for generating a laser beam 1402. The laser beam may be directed by a mirror into a polarisation sensitive beam splitter 1404 generating two linearly polarized laser beams 1405 and 1406. Each of the beams is directed through a corresponding beam expander and acousto-optic modulator. Hence, beam 1405 is directed via mirror 1421 through lenses 1407 and 1411 and acousto-optic modulator 1409, while beam 1406 is directed through lenses 1408 and 1412 and through acousto-optic modulator 1410.

The modulated beam 1405 is directed by mirror 1413 towards a beam expander 601 and a common focussing lens 109 that acts as a Fourier lens and focuses the beam via a rotating prism (not shown) on a focal spot 106 on the inner surface of the drum (not shown) as described above.

The modulated beam 1406 is the directed by a piezo-controlled or electro-magnetic adjustable mirror 1414 towards a beam expander 602 and the common focussing lens 109 that focuses the beam on focal spot 106. The adjustable mirror 1414 is positioned at a radial distance from the centre axis of the internal drum and its tilt angle and/or position is controlled to direct the beam 1406 at a varying angle into focussing lens 1419 in order to generate a parallel scan line parallel to the scan line generated by beam 1405, as described above. The beam expanders 601 and 602 and the focussing lens 109 are arranged as shown in the embodiment of FIG. 6a. Consequently, the beams 1405 and 1406 illuminate different parts of the focussing lens 109 and different parts of the prism area, thereby avoiding the need for a polarization coupling of the two beams. This is illustrated in FIG. 14b showing the prism area 143 and the cross sections of beams 1405 and 1406, respectively.

Hence, it is an advantage of the above embodiment, that it does not require a polarization coupling of the laser beams, thereby providing a low-complexity, cost effective system.

When the mirror 1414 is actuated in order to deflect the beam it is important that the beam is deflected in two directions that are perpendicular. For instance one deflection should be in a direction that is perpendicular to the beam and that lies in the plane of the drawing. The other deflection should be in a direction that is perpendicular to the beam and that lies in the plane that is perpendicular to the drawing and parallel with the beam. This could be achieved by vibrating the mirror about axes 1420 and 1421. When the mirror is rotated about axis 1420 with angle v₁ the beam will deflect by an angle 2v₁ in the plane of the paper When the mirror is rotated about axis 1421 by an angle v₂ the beam will deflect by an angle v₂ in the plane perpendicular to the drawing and parallel with the beam. From this it is seen that the two vibration axes 1420 and 1421 of the mirror should be actuated with different amplitudes in order to achieve equal beam deflections.

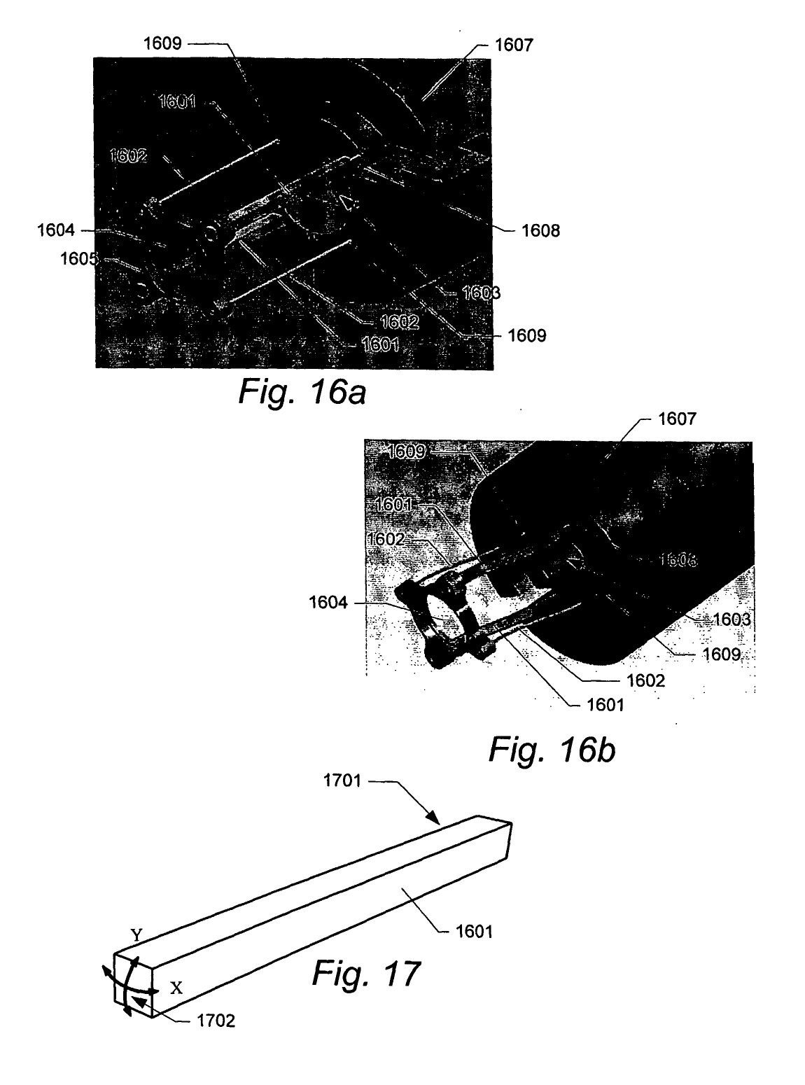

FIGS. 15a-b illustrate an embodiment of a multibeam internal drum system with three injected beams. The system schematically shown in FIG. 15a is similar to the system of FIG. 14a. However, in the present embodiment, the system comprises a polarisation coupler 1501 instead of mirror 1413. Hence, the beams 1405 and 1406 are polarisation coupled and the polarization coupled beam 1510 is directed towards the inner surface of the drum along a common beam path, i.e. through a common beam expander 601 and the same area of the focussing lens 109 and the same prism area, as illustrated in FIG. 15b. Furthermore, the system comprises a second laser 1502 generating a third laser beam 1503 which is directed via mirror 1504 through a beam expander (lenses 1505 and 1507) and acousto-optic modulator 1506. The modulated beam is directed from a piezo-controlled adjustable mirror 1508 at varying angles through beam expander 602 and focussing lens 109. Again, the mirror 1508 is controlled to cause the focal spot of beam 1503 to scan a straight line parallel to the scan lines of the other two beams. Furthermore, the mirror 1508 is positioned off-axis, i.e. at a radial distance from the centre axis, causing the beam 1503 to take a beam path different from the beam path of the other two beams, as is illustrated by FIG. 15b. Hence, in this system a third beam is injected into this system, and a skilled person will appreciate that further beams may be injected in a similar way.

FIGS. 16a-b illustrate another embodiment of an controllable optical element. In this example the optical element comprises a lens 1604 that is mounted in frame 1605. This frame 1605 is connected to a housing 1607 by two 2D piezo-benders 1601 and two elongated rods 1602 that allow a movement of the lens in a plane perpendicular to the optical axis without introducing tilts or rotation. The housing 1607 has a tubular shape with an opening 1603 for the laser beam to pass through. Around the opening 1603, the cross section of the tube comprises recesses 1608 and 1609 for receiving the benders 1601 and the rods 1602, respectively, The recesses 1608 further provide electrical contacts for applying the actuating drive signals for the benders. The present embodiment comprises two benders and two rods extending from the lens frame to the housing such that the benders are positioned on diametrically opposite sides of the optical axis thereby reducing any tilting or rotation of the lens during displacement. However, in alternative embodiments a different number of benders may be used.

It is noted that the movement of the lens further causes an insignificant displacement of the lens in the direction of the optical axis, i.e. in the longitudinal direction of the rods. However, this insignificant displacement is constant, if the movement of the lens is substantially circular, as in the above embodiments of the internal drum systems.

Hence, the 2D benders act both as a mounting rod as well as an actuator. It is an advantage of this construction that it is particularly compact in particular in the plane perpendicular to the optical axis. Furtherrnore, the mass of the moving system, which is an important parameter for the obtainable speed of the circular movement, is not increased due to the introduction of actuators. For the same reason, in one embodiment, the lens frame and the rods are made of low-weight material, such as plastic like POM.

FIG. 16b shows the lens arrangement of FIG. 16a in a displaced position caused by the bending of the piezo-benders 1601. FIG. 16b further illustrates that the bending of the 2D-benders 1601 introduces a deformation of the rods 1602 as well, thereby causing a displacement of the lens within a plane perpendicular to the optical axis without causing any rotation or tilt of the lens 1607.

Hence, the arrangement of FIGS. 16a-b provides a mechanism for introducing movements of an optical element in a predetermined plane without intrudcing tilts or rotations. The construction is particularly suitable for causing small movements by use of piezo-technology. In an alternative embodiment, analogue electromagnetic benders may be used.

FIG. 17 illustrates a 2D bender element. The bender element 1601 is a rod having a quadratic cross section 1702.

Since the piezo-elements can heat up when they work fast at large amplitudes, it is preferred to provide cooling of the piezo-elements. The benders have an inactive region 1701, where the benders do not bend, at the end proximal to the end where they are mounted. For example, the inactive region may have a length of approximately 1 Omm corresponding to the depth of the recesses 1608. Hence, the surface of the bender in the inactive region provides a contact area for transporting heat to the base mount 1607 and, thus, cooling the piezo benders.

In a preferred embodiment, the piezo-element comprises internal electrodes that can be grounded on the base mount 1607. Hence the electrodes may provide additional heat transport from the centre of the piezo element to the base mount 1607. Thereby local heating of the benders can me minimized.

FIGS. 18a-d illustrate the elimination of the error introduced by the rotating prism by means of the circular movement of a focussing lens.

FIG. 18a shows a two-beam system similar to the system shown in FIG. 1a. However, in FIG. 18a, the lenses 107 and 108 shown in FIG. 1a are omitted for convenience. A first beam 1841 propagates along the optical axis 1801, which is assumed to coincide with the centre of the drum of an internal drum image setting system (not explicitly shown in FIG. 18a). The beam is expanded in the beam expander composed by lenses 1802 and 1803. The beam is focused and reflected onto the internal surface of the drum by means of the focussing lens 1805 and a mirror 1806. A second beam 1842 propagates through a beam expander composed by lenses 1812 and 1813 where lens 1812 can be moved in a circular trajectory around the optical axis 1815 which in turn is displaced compared to the optical axis 1801. The second beam is focused and reflected onto the internal surface of the drum by means of the focussing lens 1805 and mirror 1806. In FIG. 18a, the centre (indicated by line 1814) of the moveable lens 1812 is displaced by a distance d₂ relative to the optical axis 1815 along the positive y direction of the coordinate systems 1821 and 1820. The coordinate system 1821 shows the angular position of the centre of the lens 1812 relative to the optical axis 1815 (shown by the dot C) and the direction of the focused beam in the x-y plane (shown by the triangle B). The displacement d₂ of lens 1812 in combination with the angular position θ=0 deg. of the mirror 1806 results in a displacement d₁ of the focus spot relative to the focus spot of the first beam.

In FIG. 18b the mirror 1806 has been rotated clockwise (when seen against the positive z direction) to the angular position θ=90 deg so that the focused beams are directed along the positive x-direction. It is noted that the coordinate system 1820 is rotated compared to FIG. 18a, in order to show the beam path of the second beam 1842. The first beam has been omitted in this figure for convenience. In order to ensure a constant distance d₁ between the focus spot of the second beam to the focus spot of the first beam, the lens 1812 has been moved along a circular path to a new position as shown by coordinate system 1821. Thus, the position of the centre of the lens 1812 is given by the position d₂ along the positive x-direction.

In FIG. 18c the mirror 1806 has been rotated clockwise to the angular position θ=180 deg so that the focused beams are directed along the negative y-direction. The centre of the moveable lens 1812 has been moved to the position d₂ along the negative y-direction.

In FIG. 18d the mirror 1806 has been rotated clockwise to the angular position θ=270 deg so that the focused beams are directed along the negative x-direction. The centre of the moveable lens 1812 has been moved to the position d₂ along the negative x-direction.

After another 90 degrees angular rotation of the mirror 1806 and a corresponding movement of the centre of the lens 1812, the system has returned to the initial situation shown in FIG. 18a.

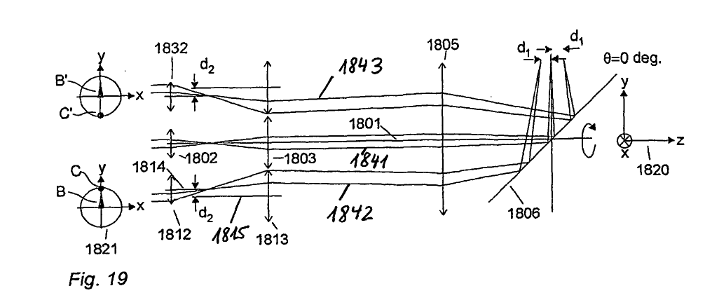

FIG. 19 illustrates a three-beam system, similar to the system of FIGS. 18a-d, but comprising a third beam 1843 displaced with respect to the centre beam 1841. The position of the centre of the lens 1832 corresponding to the angular position θ=0 deg of the mirror is shown by C′ in the coordinate system 1822. Thus, the initial position of the centre of the lens 1832 is given by the position d₂ along the negative y-axis. As the mirror rotates clockwise, the centre of the lens 1832 follows a circular path in a clockwise direction. The focus point of the third beam follows a straight path displaced by a distance do to the right of the centre focus point. The two off-axis beams 1842 and 1843 shown in FIG. 19 may be combined by a polarising beam splitter according the principle shown in FIG. 1a or the two off-axis beams may be combined without the use of a polarising beam splitter as shown in FIG. 19.

The angular separation between the moveable lenses may be different than 180 deg. For example, four moveable lenses may be mutually separated by 90 degrees, each following a circular trajectory with radius d₂. This will generate four straight lines on the internal surface of the drum with two lines being separated a distance d₁ from the zero line and two lines separated a distance d₁/2 from the centre line.

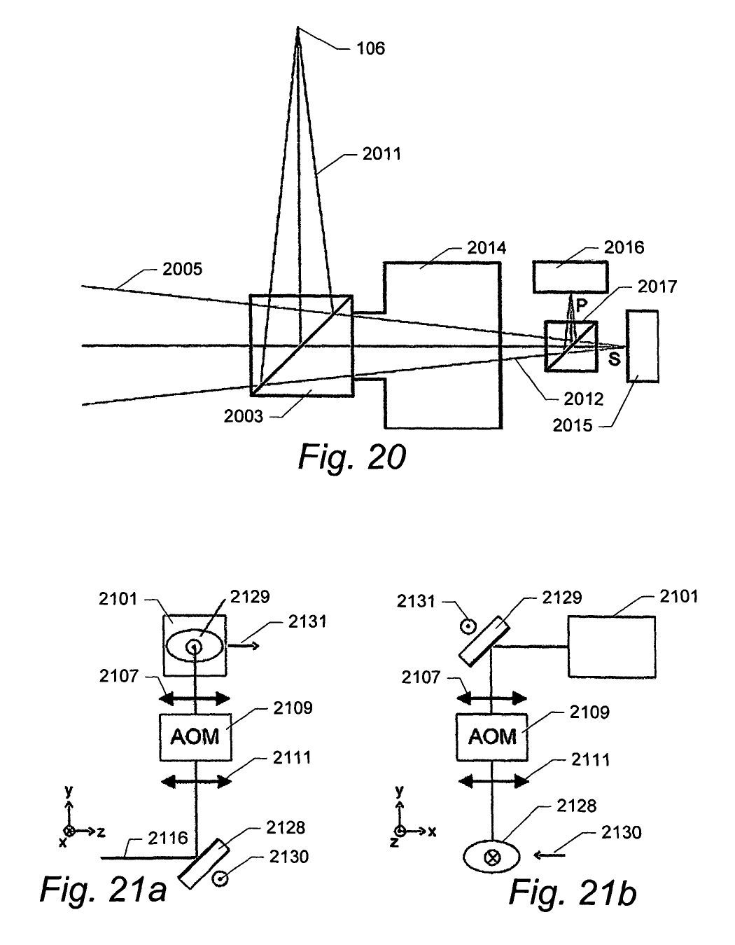

FIG. 20 shows another embodiment of an arrangement for detecting the beam positions. In particular, FIG. 20 shows a cross section of the spinner 2000 of an internal drum system, e.g. the internal drum system shown in FIG. 1a. The spinner 2000 comprises a spinner prism 2003 and a spinner housing 2014. The injected focused beam 2905 comprises two polarisation coupled beams as described above. The injected focussed beam 2005 is reflected into the beam 2011 such that it impinges the internal surface of the drum. In this embodiment, the spinner prism 2003 is partially transmitting, i.e. configured to transmit a certain percentage (e.g. 1%) of the light power into the beam 2012. The spinner housing 2014 comprises a hollow member so that the beam 2012 is transmitted through it. As described above, the beam 2012 is composed of two beams with orthogonal polarisation directions. The two beams are separated by the polarisation beamsplitter 2017 into a beam with the polarisation direction S and one with the polarisation direction P. The beam with polarisation direction S impinges on the beam position detector 2015 and the beam with polarisation direction P impinges on the beam position detector 2016. The detectors 2015 and 2016 may be four-quadrant detectors, PSD detectors, CCD detectors, or the like. The electric signal form the detectors may be amplified and processed by a computer or an electronic circuit. The position data from the detectors provides information of the position error of the focal spot 106 and, therefore the position data can be used as a feedback signal for the lens or mirror actuators.

It is an advantage of the above beam postion detector that it does not require a detector on the inner surface of the drum. Consequently, the system does not interfere with the printing process. It is a further advantage that the bandwidth of the above beam position detector does not need to be as high as the bandwidth of the beam detection system shown in FIG. 13c and, therefore, it is easier to obtain a high accuracy and resolution of the position detector.

FIGS. 21a-b illustrate an arrangement for a beam deflection including two mirrors. In particular, FIGS. 21a-b show a part of a system similar to the system in FIG. 14a. However, in the system of FIG. 21 two actuated mirrors are used in order generate two perpendicular deflections rather than the single mirror 1414 of FIG. 14a. This system has the advantage that both mirrors deflect the beam by an angle 2v₁ when the mirror is deflected by v₁. Another advantage is that it is easier to construct high performance deflection mirrors with only one deflection axis compared to a deflection mirror with two deflection axes. Thus, it is easier to realise the high requirements to accuracy and resolution of the of the deflection mirror by using two single axis mirrors compared to a two-axis mirror. In the system shown in FIGS. 21a-b the beam is propagated in two perpendicular planes. FIG. 21 shows a top view of the system (the yz plane) and FIG. 21b shows a side view of the system (the xy plane). The laser beam is propagated from the laser 2101 in the negative x-direction (The beam may also be propagated via e.g. a mirror or a beamsplitter instead of directly from the laser 2101). The mirror 2129 reflects the beam so that it propagates in the negative y-direction. The beam propagates further through the lens 2107, the AOM 2109 and the lens 21 11. These components may be omitted or placed elsewhere. Then the beam is reflected by mirror 2128 to propagate in the negative z-direction as seen in FIG. 21c. The vibration axes of the mirrors are shown in FIGS. 21a-b as axes 2130 and 2131. When the mirrors are actuated the mirrors will vibrate about these axes and deflect the beam 2116 in the direction of the x- and y-axes.

1. An internal drum scanning system comprising a cylinder having a centre axis and an inner surface providing an imaging surface to be scanned by at least two laser beams; at least one laser source for generating a first and a second laser beam; a deflector, mounted rotably relative to said cylinder around the centre axis of the cylinder, for deflecting said first and second laser beams towards said imaging surface; a first focussing lens for focussing said first and second laser beams onto respective first and second positions on said imaging surface; a first controllable optical element adapted to control the direction of the second laser beam to maintain, during relative rotation between the deflector and the cylinder, the second position fixed relative to the first position wherein the first focussing lens defines a first optical axis being imaged by said deflector onto a centre position on the imaging surface; that, during operation, the first controllable optical element is positioned such that its optical axis is displaced at a radial distance from said first optical axis; and that the first controllable optical element is adapted to direct the second laser beam onto said first focussing lens at a varying incident angle causing the first focussing lens to image the second laser beam onto the second position such that, during relative rotation between the deflector and the cylinder, the second position is fixed relative to said centre position.

2. An internal drum scanning system according to claim 1, wherein the first controllable optical element is mounted movably around the first optical axis of the first focussing lens.

3. An internal drum scanning system according to claim 2, wherein the first controllable optical element comprises a collimator lens or a second focussing lens.

4. An internal drum scanning system according to claim 1, wherein the first controllable optical element is mounted movably around a second optical axis; and wherein the internal drum scanning system further comprises means for adjusting the position of the first controllable optical element to cause the first controllable optical element to move around the second optical axis at a predetermined frequency.

5. An internal drum scanning system according to claim 4, wherein the second optical axis is positioned at a radial distance from the first optical axis.

6. An internal drum scanning system according to claim 1, wherein the first focussing lens is positioned relative to the deflector such that the optical path length from the first focussing lens to the imaging surface is substantially equal to the focal length of the first focussing lens.

7. An internal drum scanning system according to claim 1, wherein the deflector comprises a first deflection area for deflecting the first laser beam and a second deflection area for deflecting the second laser beam.

8. An internal drum scanning system according to claim 1, further comprising means for polarising the first and a second laser beam; and means for polarization coupling the second laser beam generated by the first controllable optical element with the first laser beam resulting in a combined laser beam.

9. An internal drum scanning system according to claim 1, further comprising a second controllable optical element disposed at a radial distance from said first optical axis; and that the second controllable optical element is adapted to direct the first laser beam onto said first focussing lens at an incident angle causing the focussing lens to image the first laser beam onto the first position such that the first position is fixed relative to said centre position.

10. An internal drum scanning system according to claim 1, wherein the internal drum scanning system comprises means for generating at least three laser beams; and the internal drum scanning system comprises at least two controllable optical elements, each disposed at a corresponding radial distance from said first optical axis; and wherein each of the controllable optical elements is adapted to direct a corresponding one of the at least three laser beams onto said focussing lens at a corresponding incident angle causing the focussing lens to image the corresponding laser beam onto a corresponding position such that, during relative rotation between the deflector and the cylinder, the corresponding position is fixed relative to said centre position.

11. An internal drum scanning system according to claim 1, further comprising a detector arrangement for detecting a relative position of the first and second positions on the imaging surface, and a control unit for controlling the controllable optical element, where the control system is adapted to receive a position signal from the detector arrangement, and to control the adjustable element based on the received position signal.

12. An internal drum scanning system according to claim 11, wherein the detector arrangement is positioned such that it receives at least a part of the first and second laser beams after the first and second laser beams have passed the deflector.

13. An internal drum scanning system according to claim 12, wherein the detector arrangement comprises a position sensitive detector disposed on the inner surface of the cylinder, the position sensitive detector being adapted to detect the position of a focal spot in a direction along the centre axis of the cylinder.

14. An internal drum scanning system according to claim 12, wherein the detector arrangement comprises a light detector disposed on the inner surface of the cylinder arranged to detect the a relative phase of the rotation of a focal pot around the centre axis of the cylinder.

15. An arrangement for mounting an optical element movably within a predetermined plane relative to the optical element, the arrangement comprising an optical element; a number of elongated rods extending from the optical element in a direction substantially perpendicular to the direction of the predetermined plane; a housing to which the elongated rods are connected; wherein at least a first one of said number of rods constitutes a first controllable bender element for causing the optical element to perform a movement in substantially the predetermined plane.

16. An arrangement according to claim 15, wherein a second one of said rods constitutes a second controllable bender element for causing the optical element to perform a movement in substantially the predetermined plane, and wherein the first and second bender elements are connected to the optical element at respective first and second connection points of the optical element, the first and second connection points being located on opposite sides within the predetermined plane of a centre position of the optical element.

17. An arrangement according to claim 15, wherein the bender element is 2D bender element adapted to cause movements along two directions within the predetermined plane.
